(19) United States
(12) Patent Application Publication
(10) Pub. No.: US 2005/0200710 A1
(43) Pub. Date: Sep. 15, 2005

(54) Photographing and recording system

(75) Inventors: Yoshito Suzuki, Saitama (JP); Masayoshi Kawashima, Tokyo (JP); Go Sugiura, Tokyo (JP)

Correspondence Address: GREENBLUM & BERNSTEIN, P.L.C., 1950 ROLAND CLARKE PLACE, RESTON, VA, 20191, US

(73) Assignees: Yoshito SUZUKI, Saitama (JP); PENTAX Corporation, Tokyo (JP)

(21) Appl. No.: 11/073,589

(22) Filed: Mar. 8, 2005

(30) Foreign Application Priority Data
Mar. 9, 2004 (JP) 2004-110528
Dec. 16, 2004 (JP) 2004-363771

(51) Int. Cl. H04N 5/225

(52) U.S. Cl. 348/207.99

(57) ABSTRACT

A photographing and recording system including an electronic instrument with a photographing function, has a transmitter, a receiver, a sound data processor, an imaging device, an image data processor, and an image and sound recorder. The transmitter has a microphone provided for an object, and sends sound signals obtained by the microphone. The receiver receives the wireless sound signals sent from the transmitter. The sound data processor generates sound data on the basis of the sound signals. The imaging device produces image-pixel signals corresponding to an object image. The image data processor generates image data on the basis of the image-pixel signals. The image and sound recorder records the image data and the sound data in a memory while relating the image data and the sound data to each other, such that the sound data is read in accordance with the reading of the image data.

### BACKGROUND OF THE INVENTION

1. Field of the Invention

The present invention relates to an electronic instrument with a photographing function, such as a digital still/movie camera, a cellular-phone with a camera, and so on. Especially, it relates to a recording process for sounds, such as voices, and images.

2. Description of the Related Art

In a digital still camera, a movie image can be photographed in addition to a still image. Further, sounds such as voices can be recorded when taking a still image or movie image. A microphone is installed in a camera body. When recording a sound and movie image, sounds are converted to electric signals by the microphone installed in the camera body. Then, sound data is generated by a signal processor, and stored in a memory with image data. The microphone collects sounds in an area close to the camera, such as the voice of the user (photographer), or the voice of someone close to the camera.

### SUMMARY OF THE INVENTION

An object of the present invention is to provide a photographing and recording system included in an electronic instrument with a photographing function, which is capable of recording sounds of an object at a remote distance from the electronic instrument such as a camera, and producing the image data and corresponding sound data at the same time when using the recorded image and sound data at a personal computer. The electronic instrument is, for example, a mobile electronic instrument, such as a digital still/movie camera, a cellular-phone with a camera, and so on. The photographing and recording system according to the present invention has a remote transmitter, a receiver, a sound data processor, an imaging device, an image data processor, and an image and sound recorder. For example, the electronic instrument has an imaging device, an image data processor, a sound data processor, and an image and sound recorder.

The transmitter has a remote microphone, and transmits sound signals obtained by the microphone. For example, the sound signals are transmitted by FM, or signals defined by the wireless standard “Bluetooth”. The receiver receives the sound signals transmitted from the remote transmitter by wireless transmission. The sound data processor generates sound data on the basis of the sound signals. The imaging device produces image-pixel signals corresponding to an object image. The image data processor generates image data on the basis of the image-pixel signals. Then the image and sound recorder records the image data and the sound data in a memory. At this time, the image and sound recorder records the image data and the sound file while relating the image data and the sound data to each other, such that the sound data is read in accordance with the reading of the image data.

The receiver may be provided in the electronic instrument, or the receiver may be connected to the electronic instrument. The electronic instrument may have a recording jack that has an input terminal for the sound signals, and the receiver may have a sound signal cable that is plugged to the input terminal to connect the transmitter to the electronic instrument.

For example, the image and sound recorder makes an image file for the image data and assigns a file name to the image file. Then, the image and sound recorder makes a sound file for the sound data and assigns it a file name associated with the file name of the image file. A file name identical with that of the image file may be assigned to the sound file so long as the extension is different.

As for the start of the recording, a sound recording initiator may be provided. The sound recording initiator has a sound recording button provided on the electronic instrument and initiates the recording of sounds. The image and sound recorder records the sound data while the sound recording button is operated. On the other hand, the recording process may be automatically performed. The system may include a recording button that is provided on the electronic instrument, for initiating an image recording process. The image and sound recorder records the sound data during a sound recording interval, which includes the time interval that the recording button is depressed. The sound recording interval further includes a previous time interval before the recording button is depressed and a following time interval after the recording button is released.

To turn the remote microphone positioned close to the object ON, a microphone initiator may be provided on the electronic instrument. To start the recording process by the remote microphone close to the object, a recording initiator may be provided on the remote transmitter, that initiates the recording of sounds.

An electronic instrument with a photographing function according to another aspect of the present invention has a receiver, a sound data processor, an imaging device, and an image data processor. The receiver receives sound signals that are obtained by the remote microphone, which are sent by wireless communication. The sound data processor generates sound data on the basis of the sound signals. The imaging device produces image-pixel signals corresponding to an object image. The image data processor generates image data on the basis of the image-pixel signals. The image and sound recorder records the image data and the sound data in a memory while relating the image data and the sound data to each other, such that the sound data is read in accordance with the reading of the image data.

An electronic instrument with a photographing function according to another aspect of the present invention has an imaging device, an image data processor, a recording jack, a sound data processor, and an image and sound recorder. The imaging device produces image-pixel signals corresponding to an object image. The image data processor generates image data on the basis of the image-pixel signals. The recording jack has an input terminal for connecting a signal cable, the signal cable transmitting sound signals that were obtained by a remote microphone, and sent in wireless format by a remote transmitter, to a receiver connected to the signal cable. The sound data processor generates sound data on the basis of the sound signals. The image and sound recorder records the image data and the sound data in a memory while relating the image data and the sound data to each other, such that the sound data is read in accordance with the reading of the image data.

A method for recoding images and sounds using an electronic instrument according to another aspect of the present invention includes: i) preparing two cellular-phones; ii) connecting one cellular-phone that is used to receives sound signals, to the electronic instrument; iii) providing the other cellular-phone that is used to send sound signals, to an object or subject; iv) operating the two cellular-phones to contact each other; and v) recording sound data corresponding to the object and image data of the object or subject while relating the image data and the sound data to each other, such that the sound data is read in accordance with the reading of the image data.

A method for recording images and sounds using a cellular-phone with an electronic instrument according to another aspect of the present inventions includes: i) providing a cellular-phone that is used to send signal sounds, to an object or subject; ii) initiating contact between the two cellular-phones; and iii) recording sound data corresponding to the object and image data of the object while relating the image data and the sound data to each other, such that the sound data is read in accordance with the reading of the image data.

### BRIEF DESCRIPTION OF THE DRAWINGS

The present invention will be better understood from the description of the preferred embodiment of the invention set fourth below together with the accompanying drawings, in which:

FIG. 1 is a schematic view of a digital camera according to a first embodiment;

FIG. 2 is a block diagram of the digital camera;

FIG. 3 is a block diagram of a digital camera according to a second embodiment;

FIG. 4 is a view showing a digital camera according to a third embodiment;

FIG. 5 is a block diagram of the digital camera according to the third embodiment;

FIG. 6 is a block diagram of a digital camera according to a fourth embodiment;

FIG. 7 is a view showing a digital camera and a pair of cellular-phones according to a fifth embodiment;

FIG. 8 is a view showing a method for using the digital camera and the cellular-phones according to the fifth embodiment;

FIG. 9 is a view showing a pair of cellular-phones according to a sixth embodiment; and

FIG. 10 is a view showing a method for using of the cellular-phones according to the sixth embodiment.

### DESCRIPTION OF THE PREFERRED EMBODIMENTS

Hereinafter, the preferred embodiments of the present invention are described with reference to the attached drawings.

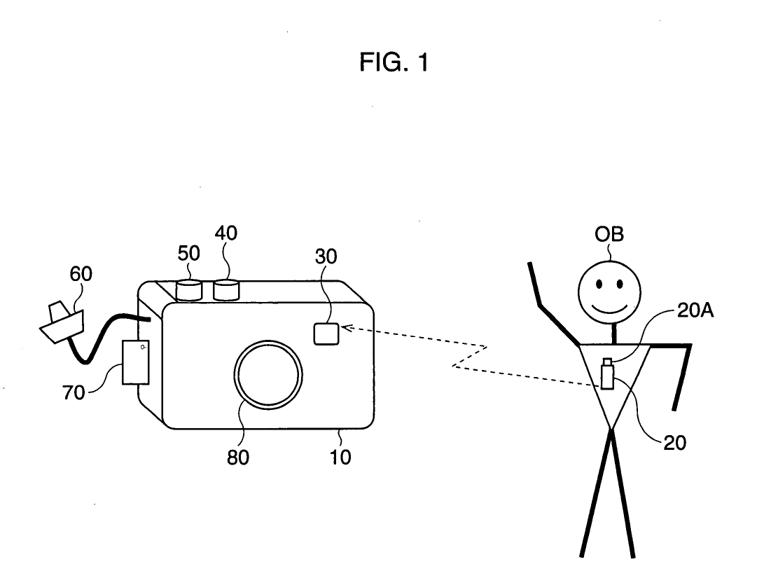

FIG. 1 is a schematic view of a digital camera according to the first embodiment.

The digital camera 10 is a digital still camera capable of receiving wireless signals and capable of recording images and sounds such as voices, or speech. A remote transmitter 20 with a microphone 20A, which is attached to a person or object OB, sends analog sound signals to the digital camera 10. Sounds, such as voices and the like from the object OB or person, are converted to electric signals, and the remote transmitter 20 transmits the sound signals to the camera 10 by wireless communication, such as FM. On the front surface of the digital camera 10, a photographing lens 80 and a receiving window 30 are provided. The sound signals are received by the camera 10 via the receiving window 30. A release button 40 and a sound-recording button 50 are provided on the upper surface of the digital camera 10, and an earphone 60 is connected to the side surface of the camera 10. A card slot is formed on the side surface of the camera 10, and a memory card 70 for recording image data and sound data is detachably installed in the card slot.

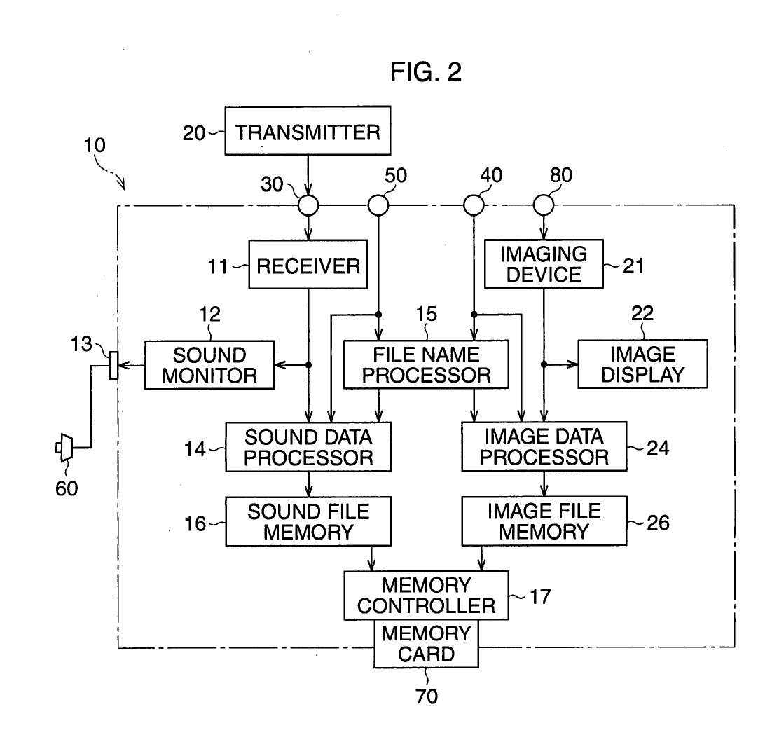

FIG. 2 is a block diagram of the digital camera 10. A receiver 11 receives the sound signals transmitted from the transmitter 20. A sound monitor 12 outputs the sound signals to the earphone 60 via an earphone jack 13. The earphone 60 is used when listening to the recorded voices while viewing the photographed images.

A sound data processor 14 generates digital sound data on the basis of the received sound signals, and makes a sound file composed of the sound data and assigns a file name to the made sound file. A file name processor 15 makes a sound file name on the basis of the photograph date and the picture number indicating a photographing order. The sound file, generated at the voice data processor 14, is stored in a sound file memory 16. The sound file memory 14 acts in accordance with the operation to the sound-recording button 50. Namely, the sound file memory 16 stores the sound file while the sound-recording button 50 is ON. One sound file is made and is stored in the sound file memory 16 every time that the sound-recording button 50 is turned ON. When the release button 40 is not depressed in a situation where the sound-recording button 50 is ON, only the sound file is stored in the sound file memory 16.

An imaging device 21 has a CCD (not shown). Light reflected from the object OB passes through the photograph lens 80 so that an object image is formed on a light-receiving area of the CCD. In the imaging device 21, image-pixel signals are generated by the photoelectric effect and are subjected to various signal processes, such as amplifying, white balance adjustment, and so on. Consequently, analog image signals are generated. The image signals are fed to an image data processor 24 and an image display 22. The image display 22 displays the object image on the basis of the image signals fed from the image processor 21. On the other hand, the image data processor 24 converts the image signals to digital image data. Further, the image data processor 24 makes an image file and assigns a file name fed from the file name processor 15 to the image file.

The image file is stored in an image file memory 26. The image file memory 26 acts in accordance with the operation of the release button 40. Namely, the sound file memory 26 stores the sound file when the release button 40 is depressed. In the digital camera 10, a photograph mode can be changed from a still image mode to a movie image mode by operating a mode button (not shown). Therefore, when the release button 40 is depressed, one image file corresponding to the still image is stored in the image file memory 26, or a series of image files corresponding to the movie image are stored in the image file memory 26 while the release button 40 is depressed.

The file name processor 15 names the sound file and the image file such that the sound file name and the image file name are related with each other. Concretely speaking, the file name processor 15 assigns a file name of a sound file, which corresponds to a present sound recording, to the image file. Herein, a sound file name, which is composed of an order number of recording and an identifier indicating the sound data, is assigned to the sound file. The image file name is constructed of a numerical number and an identifier indicating the image data. The file name processor 15 names the image file such that the numerical number is identical with an order number of a corresponding sound file obtained by the present recording. For example, a file name of the image file is set to “04010101.jpg”, and a file name of the sound file is set to “04010101.wav”.

When the movie mode is selected, a series of successive image files is made in accordance with a series of images. Herein, a branch number or an alphabet, indicating a recording-order of the series of images, is added to the image file name, namely, the numerical number. For example, a file name of the sound file is set to “04010101.wav”, and file names of the series of image files are respectively set to “04010101a.jpg”, “04010101b.jpg”, . . . .

A memory controller 17 connects the voice file in the sound file memory 16 to the corresponding image file in the image file memory 26, and records the image file and the sound file on the memory card 70. The memory card 70 is detached from the camera 10 and is installed in a computer (not shown). When reading the image file in the memory card 70, a corresponding sound file can be simultaneously read from the memory card 70 as the sound file name (order number) identical with the image file name (numerical number).

In this way, in the first embodiment, voices of the object OB, which stands remote from the camera 10, are collected by the microphone 20A and are transmitted from the transmitter 20 to the digital camera 10. In the digital camera 10, sound files and image files are generated and are related with each other.

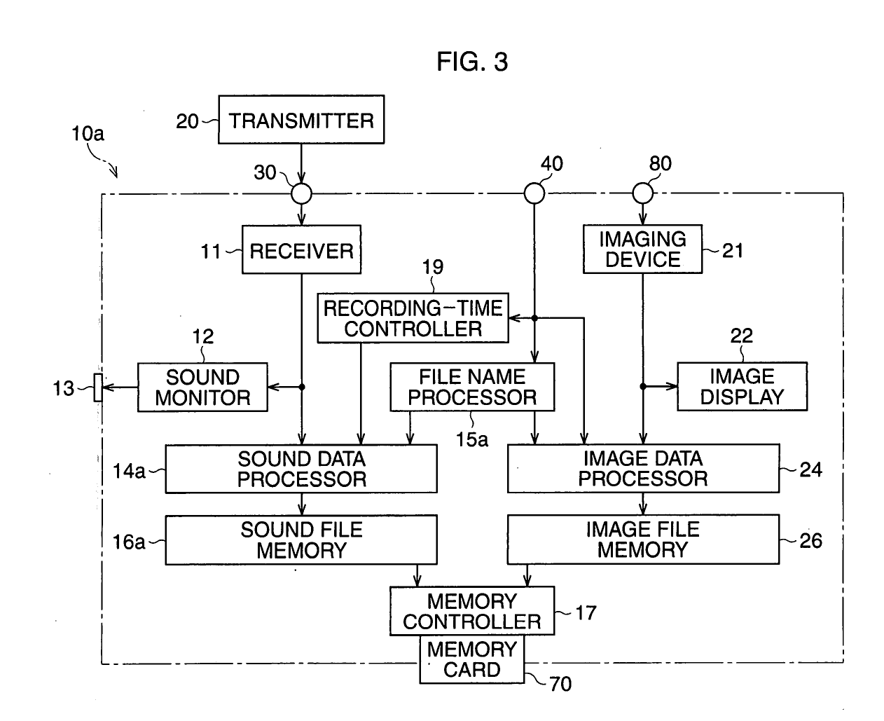

With reference to FIG. 3, the second embodiment is explained. The second embodiment is different from the first embodiment in that a sound recording process is automatically performed. Other constructions are similar to those of the first embodiment. Constructions the same as those in the first embodiment are designated by the same reference numerals.

FIG. 3 is a block diagram of a digital camera according to the second embodiment.

The digital camera 10 has a recording-time controller 19 that controls a storing-time of the sound file. Herein, the recording-time controller 19, a sound data processor 14a, and a sound file memory 16a are constructed of a FIFO (first in first out) circuit. While the digital camera 10a is ON, the digital sound data is continuously generated in the sound data processor 14a. After, the sound file is generated in the sound data processor 14a, and is stored in the sound file memory 16a. The recording-time controller controls the recording time such that the sound file constructed of sound data generated in a predetermined time-interval “T1” is continuously generated by being updated every time a predetermined time “T1” passes. A previous sound file is stored in the memory 16a until the time “T1” passes, and the previous sound file is automatically deleted and a new sound file is rewritten in the sound file memory 16a when the time “T1” passes. While photographing is not performed, the time “T1” worth of the sound file is stored and updated in the sound file memory 16a.

When the release button 50 is depressed, the recording-time controller 19 stops deleting the time “T1” worth of sound file “V1” generated in the sound data processor 14a. On the other hand, while the release button 40 is depressed, sound data (herein the release button 50 is depressed in a time-interval “T2”) is generated. Further, after the release button 50 is released, a time-interval “T3” worth of sound data is generated. The sound data processor 14a makes a sound file, which is composed of the time “T1” worth of sound data, the time “T2” worth of sound data, and the time “T3” worth of sound data, and stores the sound file in the sound file memory 16a.

Similarly to the first embodiment, the image data is generated on the basis of image-pixel signals red from the CCD in the imaging device 21, and the named image file is stored in the image file memory 26. A file name processor 15a assigns a file name, which is identical with or associated with that of the image file generated by depression of the release button 40, for the sound file of the time intervals “T1”+“T2”+“T3”.

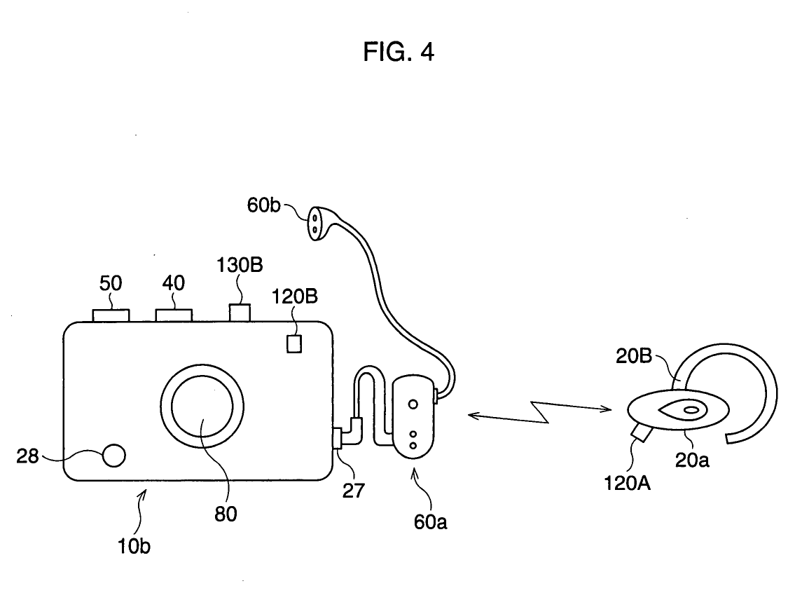

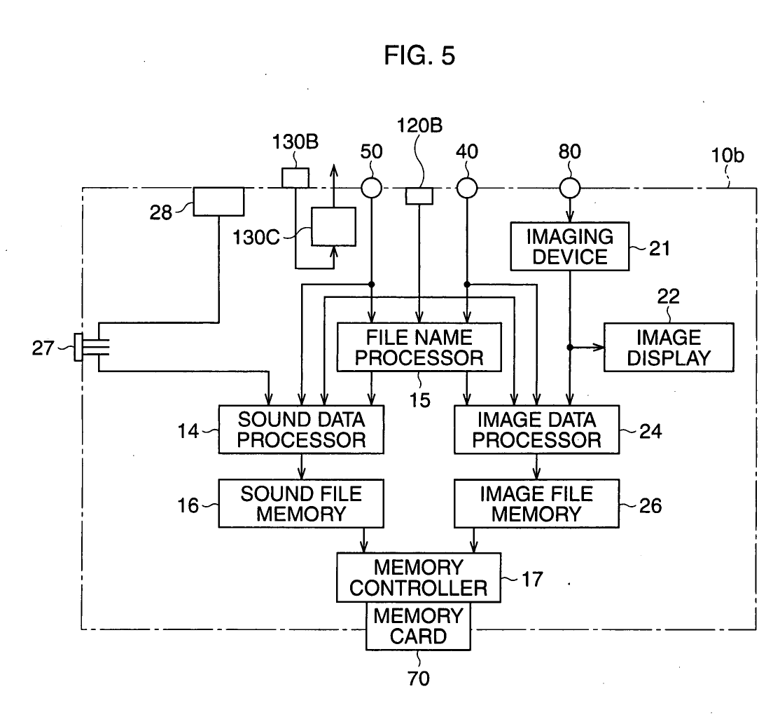

With reference to FIGS. 4 and 5, the third embodiment is explained. The third embodiment is different from the first embodiment in that a receiver is connected to the camera and sound signals are input via a jack. Other constructions are similar to those of the first embodiment. The same construction elements as those in the other embodiments are designated by the corresponding reference numerals.

FIG. 4 is a view showing a digital camera according to the third embodiment.

A transmitter 20a with a microphone 20B is held by a subject, and transmits sound signals to the digital camera 10b in a wireless form such as FM. The digital camera 10b is connected to a receiver set 60a including an earphone 60b. The receiver set 60a receives sound signals sent from the transmitter 20a, and the sound signals are input to the digital camera 10b via a recording jack 27. A microphone 28 provided on the camera 10b is used for recording sounds of an object close to the camera 10b.

The transmitter 20a has a recording button 120A and a transmitting circuit (not shown) that transmits infrared light for starting the photography. The digital camera 10b has an infrared light receiver 120B for receiving the infrared light. Further, the digital camera 10b has a microphone button 130B for turning the microphone 20B ON, whereas the transmitter 20a has a recording detector (not shown) that detects signals sent from the camera 10b by depressing the microphone button 130B.

FIG. 5 is a block diagram of the digital camera 10b. When the receiver set 60a is connected to the recording jack 27, the sound signals are input to the sound data processor 14, wherein the digital sound data is generated. On the other hand, when the receiver set 60a is detached from the recording jack 27, sound signals sent from the microphone 28 are input to the sound data processor 14. The photographer can hear sounds sent from the object by the earphone 60b shown in FIG. 4.

When the microphone button 130B is depressed, a transmitter 130C transmits signals, which turn the microphone 20B ON, to the transmitter 20a. On the other hand, when the recording button 120A is depressed, the infrared light receiver 120B receives infrared light, and outputs detecting signals to the sound data processor 14, the file name processor 15, and the image data processor 16. Thus, the recording process of sounds is started. Similarly to the first embodiment, a sound file and an image file are generated and stored. Then, associated file names are assigned to the sound file and the image file.

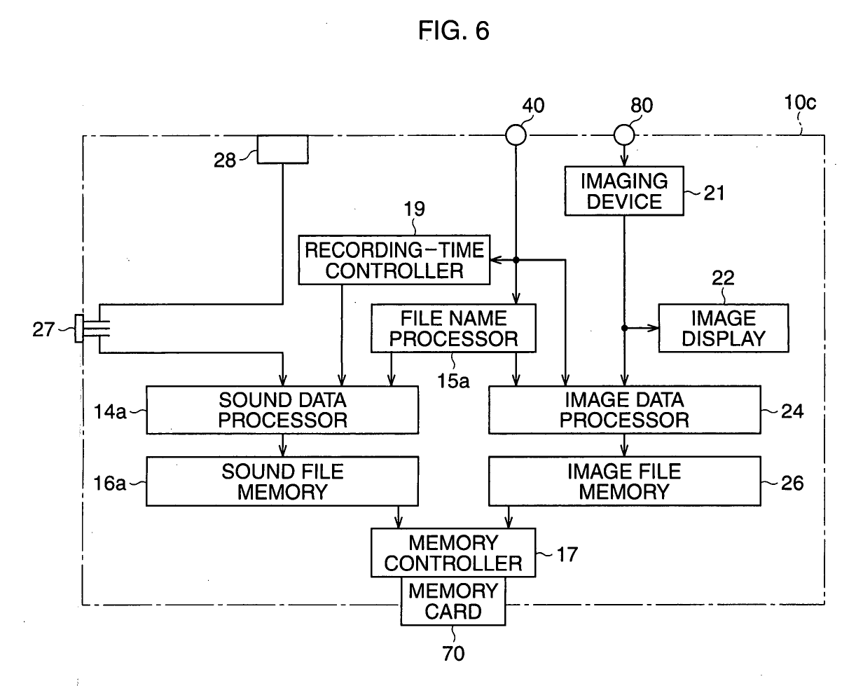

With reference to FIG. 6, the fourth embodiment is explained. FIG. 6 is a block diagram of a digital camera according to the fourth embodiment. In the fourth embodiment, similarly to the second embodiment, the sound data is generated while the digital camera 10c is ON, and the sound file corresponding to the time-intervals “T1”+“T2”+“T3” is generated. Other constructions are similar to those of the third embodiment.

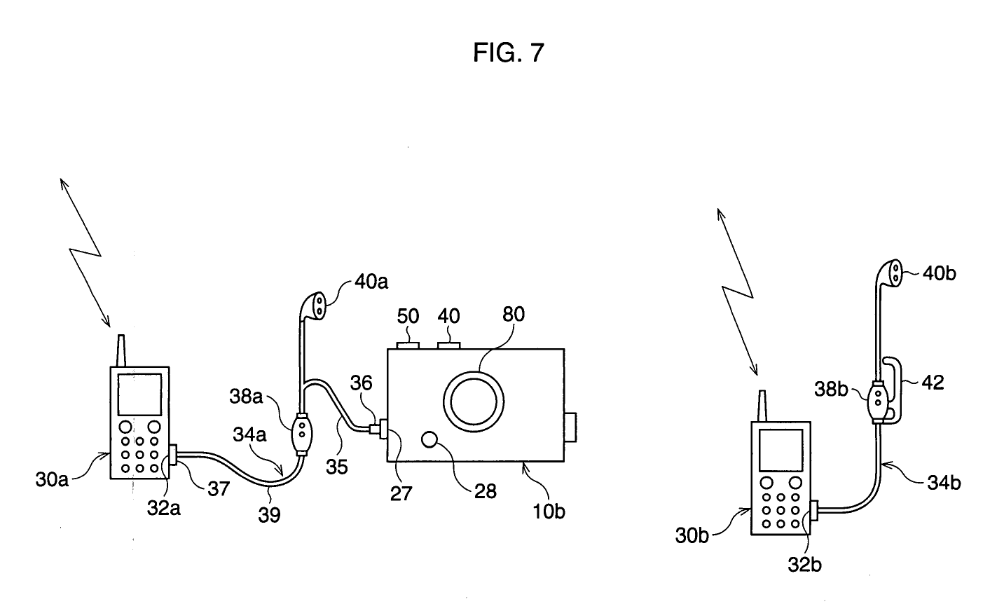

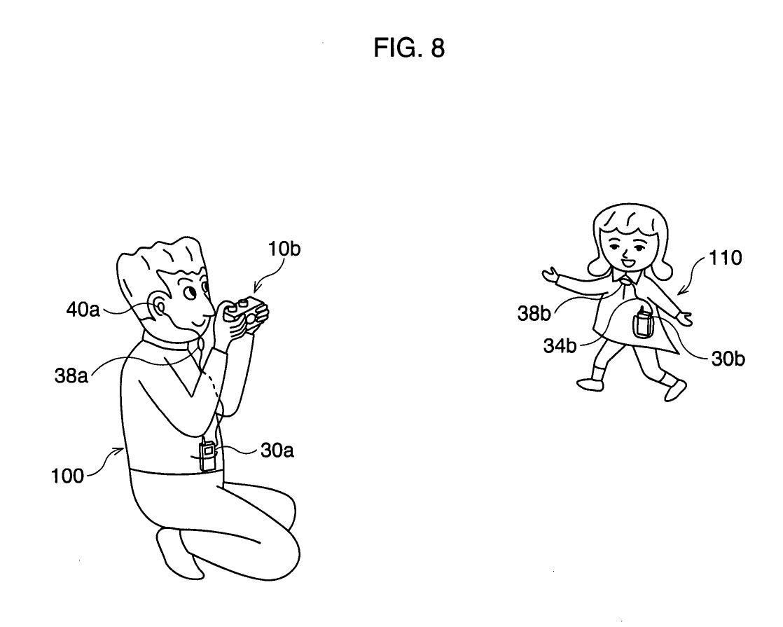

With reference to FIGS. 7 and 8, the fifth embodiment is explained. The fifth embodiment is different from the third embodiment in that a cellular-phone is applied. Other constructions are similar to those of the third embodiment.

FIG. 7 is a view showing a digital camera and a pair of cellular-phones according to the fifth embodiment. FIG. 8 is a view showing a method for using the digital camera and the cellular-phones.

A recording adapter 34a, which has a connecting cable 39, a microphone 38a, and an earphone 40a, is connected to the digital camera 10b. The recording adapter 34a forks at the microphone 28. The end 37 of the cable 39 is connected to an earphone-microphone jack 32a of the cellular-phone 40a, whereas the cable 35 extends from the microphone 38a and the end 36 of the cable 35 is connected to the recording jack 27 on the digital camera 10b. A microphone set 34b with an earphone 40b and a microphone 38b is connected to an earphone-microphone jack 32b on a cellular-phone 30b. The microphone-pin 42 is connected on the garment of the object 110.

The cellular-phone 30b is turned ON, and an automatic telephone-call mode is set. Thus, telephone-call is automatically set and the photographer 100 can hear voices of the object 110 by using the cellular-phones 30a. When the object 110 speaks, voice signals are wirelessly transmitted from the cellular-phone 30b to the cellular-phone 30a. Then, the voice signals are input to the camera 10b via the recording adapter 34a. The recording process of an image file and a sound file is the same as that of the third embodiment.

In this way, in the fifth embodiment, the cellular-phones 30a and 30b are used so that voices are clearly recorded. Note that, the camera according to the second embodiment (See FIG. 3) may be applied in place of the camera 10b.

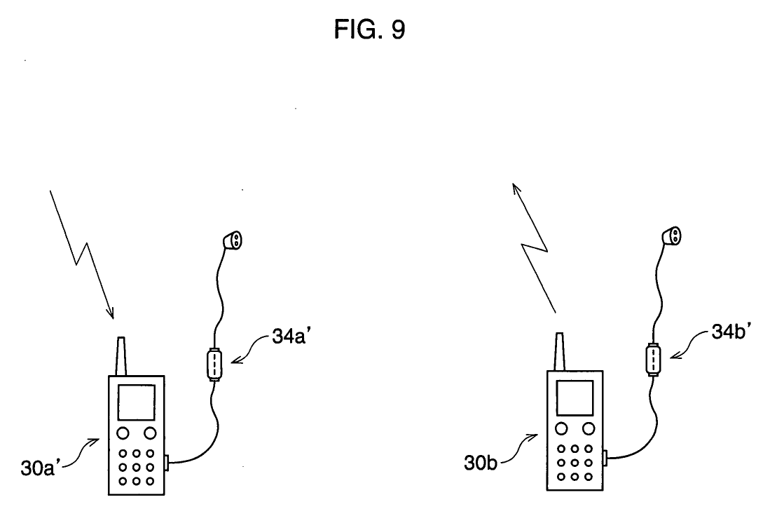

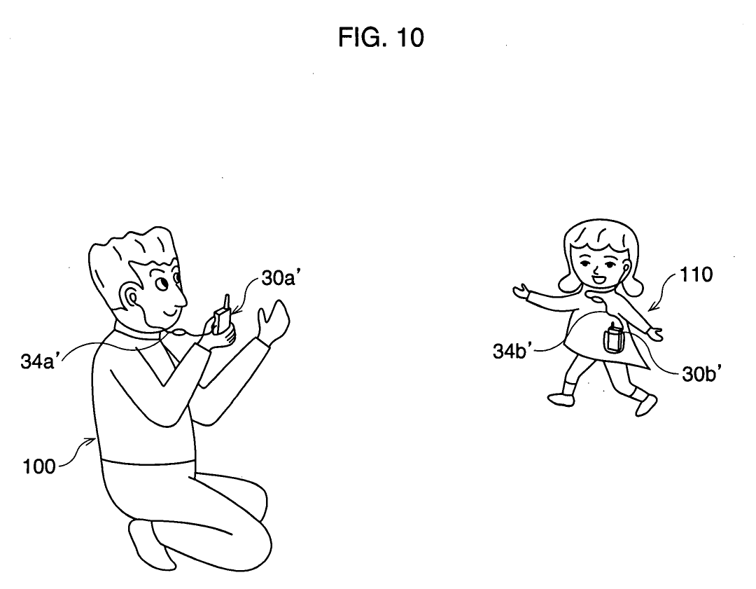

With reference to FIGS. 9 and 10, the sixth embodiment is explained. The sixth embodiment is different from the fifth embodiment in that a cellular-phone with a camera is applied.

FIG. 9 is a view showing a pair of cellular-phones. FIG. 10 is a view showing a method for using the cellular-phones.

A cellular-phone 30a′ has a camera with a zoom function. An earphone 34a′ is connected to the cellular-phone 30a′, whereas an earphone 34b′ is connected to the other cellular-phone 30b′. The construction of the cellular-phone 30a′ associated with the photograph function is substantially the same as that of the camera according to the third embodiment.

Finally, it will be understood by those skilled in the art that the foregoing description is of preferred embodiments of the device, and that various changes and modifications may be made to the present invention without departing from the spirit and scope thereof.

The present disclosure relates to subject matters contained in Japanese Patent Applications No. 2004-110528 (filed on Mar. 9, 2004), No. 2004-363771 (filed on Dec. 16, 2004), which are expressly incorporated herein, by reference, in their entireties.

1. A photographing and recording system including an electronic instrument with a photographing function, comprising:
a transmitter that has a microphone, and wirelessly transmits sound signals obtained by said microphone;
a receiver that receives wireless sound signals transmitted by said transmitter;
a sound data processor that generates sound data on the basis of the sound signals;
an imaging device that produces image-pixel signals corresponding to an object image;
an image data processor that generates image data on the basis of the image-pixel signals; and
an image and sound recorder that records the image data and the sound data in a memory while relating the image data and the sound data to each other, such that the sound data is read in accordance with the reading of the image data.

2. The photographing and recording system of claim 1, further comprising a microphone initiator that is provided at said electronic instrument and initiates the turning on of said microphone.

3. The photographing and recording system of claim 1, further comprising a recording initiator that is provided at said transmitter and initiates the recording of sounds.

4. The photographing and recording system of claim 1, wherein said image and sound recorder makes an image file for the image data and assigns a file name to the image file,
wherein said image and sound recorder makes a sound file for the sound data and assigns a file name, associated with the file name of the image file, to the sound file.

5. The photographing and recording system of claim 1, further comprising a sound recording initiator that has a sound recording button provided on said electronic instrument and initiates the recording of sounds,
wherein said image and sound recorder records the sound data while said sound recording button is operated.

6. The photographing and recording system of claim 1, further comprising a recording button that is provided on said electronic instrument and initiates an image recording process,
wherein said image and sound recorder records the sound data during a sound recording interval including a time interval that said recording button is depressed, the sound recording interval further including a previous time interval before said recording button is depressed and a following time interval after said recording button is released.

7. The photographing and recording system of claim 1, wherein said receiver is provided in said electronic instrument.

8. The photographing and recording system of claim 1, wherein said electronic instrument has a recording jack that has an input terminal for the sound signals,
wherein said receiver has a sound signal cable that is plugged in the input terminal to connect said receiver to said electronic instrument.

9. An electronic instrument with a photographing function comprising:
a receiver that receives sound signals that are obtained by an outside microphone for an object and that are transmitted wirelessly;
a sound data processor that generates sound data on the basis of the sound signals;
an imaging device that produces image-pixel signals corresponding to an object image;
an image data processor that generates image data on the basis of the image-pixel signals; and
an image and sound recorder that records the image data and the sound data in a memory while relating the image data and the sound data to each other, such that the sound data is read in accordance with the reading of the image data.

10. An electronic instrument with a photographing function comprising:
an imaging device that produces image-pixel signals corresponding to an object image;
an image data processor that generates image data on the basis of the image-pixel signals;
a recording jack that has an input terminal for connecting a signal cable, said signal cable transmitting sound signals that are obtained by an outside microphone for an object, are sent from an outside transmitter wirelessly, and are received by a receiver connected to said signal cable;
a sound data processor that generates sound data on the basis of the sound signals; and
an image and sound recorder that records the image data and the sound data in a memory while relating the image data and the sound data to each other, such that the sound data is read in accordance with the reading of the image data.

11. A method for recoding images and sounds using the electronic instrument according to claim 10, comprising:
preparing two cellular-phones;
connecting one cellular-phone that is used to receives sound signals, to said electronic instrument;
providing the other cellular-phone that is used to send sound signals, to an object;
setting said two cellular-phones to a telephone-call situation; and
recording sound data corresponding to the object and image data of the object while relating the image data and the sound data to each other, such that the sound data is read in accordance with the reading of the image data.

12. A method for recording images and sounds using a cellular-phone with the electronic instrument according to claim 9, comprising:
providing another cellular-phone that is used to send signal sounds, to an object;
setting said two cellular-phones to a telephone-call situation; and
recording sound data corresponding to the object and image data of the object while relating the image data and the sound data to each other, such that the sound data is read in accordance with the reading of the image data.
